(19) United States
(12) Patent Application Publication
(10) Pub. No.: US 2010/0077163 A1
(43) Pub. Date: Mar. 25, 2010

(54) Memory Management Method, Memory Management Apparatus, and Recording Medium Recording the Memory Management Program

(75) Inventors: Tomoharu Ugawa, Chofu-shi (JP); Taiichi Yuasa, Kyoto (JP)

Correspondence Address: CROWELL & MORING LLP;INTELLECTUAL PROPERTY GROUP, P.O. BOX 14300, WASHINGTON, DC, 20044-4300, US

(73) Assignee: KYOTO UNIVERSITY, KYOTO-SHI (JP)

(21) Appl. No.: 12/525,650

(22) PCT Filed: Jan. 23, 2008
(86) PCT No.: PCT/JP2008/050897

§ 371 Date: Aug. 3, 2009

(30) Foreign Application Priority Data
Feb. 5, 2007 (JP) 2007-026111

(51) Int. Cl. G06F 12/16; G06F 12/00

(52) U.S. Cl. 711/162; 711/E12.001; 711/E12.103

(57) ABSTRACT

In a memory management method, a memory management device, and a recording medium containing a memory management program, a main program executes a process by interrupting a process for generating a continuous usable region. When the main program writes data into a heap region during a compaction process, the memory management program judges whether the data write destination is a recording region of the object to be copied or a recording region of the copied object. If the data write destination is one of those recording regions, then the write data is written into both the recording regions of the object to be copied and the copied object. For this, even if the main program performs writing during a compaction process, it is possible to maintain consistency between data on the object to be copied and the copied object.

### TECHNICAL FIELD

The present invention relates to a memory management method, a memory management apparatus, and a recording medium which records a memory management program.

### BACKGROUND ART

A program which is created using a programming language to generate a dynamic data such as Java language (abbreviated as the main program hereinafter) records the generated data in a memory area dynamically, so that a free area which the main program can use (abbreviated as the available area hereinafter) becomes insufficient unless the data, which becomes unnecessary as the execution of the main program progresses, is deleted. Consequently, there is a known method for deleting the unnecessary data in the memory area and reusing the memory area conventionally.

A process of deleting the unnecessary data in the memory area to reuse the area is called as garbage collection (abbreviated as the GC hereinafter). A process of collecting the available area which becomes reusable by the GC process together to make the available area continuous is called as compaction. The above process which enables the memory area to be reusable is necessary when executing the main program. When the main program executes the process which requires real time effectiveness, the GC process and the compaction process need to be executed in parallel with the process of the main program substantially.

In the compaction process, a referential destination of a pointer which refers to a position of a move source data is updated to a position of a move destination data after a necessary data in the memory area is moved so that the available are collected together. After the data is moved in the compaction process, when the main program refers to the move source data before the referential destination of the pointer is updated, a malfunction occurs in the process of the main program by the reason that there is no data in the move source data. Due to this, the compaction process cannot be interrupted until the referential destinations of all pointers which refer to the positions of the move source data are updated to the positions of the move destination data. As a result, real time effectiveness of the main program is reduced.

The GC process can be executed without reducing real time effectiveness of the main program according to the invention suggested by one of the inventor of the present invention in Japanese Patent No. 3,530,887. However, in the above invention, the compaction process to generate the continuous available area cannot be interrupted, and the main program cannot execute the process until the compaction process is completed.

Conventionally, KVM (K Virtual Machine) is commonly used as a built-in Java processing system in a mobile phone, which is a small item, and so on. A program which executes the above GC process and the compaction process (abbreviated as the memory management program) is applied to the KVM, and the program is automatically executed when the available area in the memory area becomes insufficient. As a result, the process of the memory management program cannot be interrupted, so that the execution of the main program is often interrupted for milliseconds to seconds.

In contrast, when executing a process which the main program requires real time effectiveness, for example, a process of an animation or moving a character in a game on a screen which requires a smooth movement, some conventional mobile phone mandatorily executes the memory management program just before executing the process which requires real time effectiveness so that the memory management program is not automatically executed during the execution of the main program. Accordingly, a size of the available area becomes large and the memory management program does not need to be executed for a while, so that the main program can execute the process without reducing real time effectiveness.

However, a timing for executing the memory management program mandatorily is often different due to differences in a process which requires real time effectiveness, a size of a memory area which varies according a type of mobile phone, and a processing speed of the main program. As a result, a developer needs to set up the timing for executing the memory management program mandatorily in view of the differences, so that a time and effort is required for the development and the development is not efficiently promoted.

In a non-patent document 1, a compaction process in a whole memory area, to which the GC process is completed, is disclosed. At first, the memory area is divided into sixteen areas, for example, and one of the sixteen areas in the memory area is determined to be a limited area. Data in the limited area is moved together to the memory area which is not included in the limited area, and subsequently, referential destinations of pointers which refer to the data in the limited area are updated together in the compaction process. However, as for the above compaction process, the whole process of updating the referential destinations of all the pointers which refer to the move source after moving the data needs to be executed together, so that the compaction process cannot be interrupted to execute the main program. As a result, real time effectiveness of the main program is reduced.

In a non-patent document 2, a process to generate a continuous available area is disclosed. At first, a memory area is divided into several areas, and one of the several areas is set as a move destination area of data, and subsequently, a main program records the data in the memory area except for the move destination area. One of the memory areas except for the move destination area of the data is determined to be a move source area of the data, and the data in the move source area is moved to the move destination area, so that the continuous available area is generated. However, in the same manner as the non-patent document 1, this process does not also enable the interruption of the compaction process to execute the main program, so that real time effectiveness of the main program is reduced. Moreover, as for this process, the move destination area of the data needs to be set up before the main program records the data in the memory area, so that the move destination area cannot be set up in view of a state of recording the data in the memory area, and so on, and the available area cannot be generated efficiently.

In general, the main program executes a readout process of the data from the memory area far more frequently than a writing process of the data to the memory area. Accordingly, when adding a particular process to the readout process of the data, overhead increases during the readout of the data, and execution efficiency of the main program often reduces. There is a known method that in the process of the above non-patent document 2, forwarding pointers which indicates positions of newest data are added in heads of respective data, and when the main program reads out a data element, the data element is read out from the position of the newest data by following the forwarding pointers. However, also in this process, the overhead increases during the readout of the data, and the execution efficiency of the main program often reduces.

Non-patent document 1: Parallel Incremental Compaction (U.S. 2004/0128329 A1)
Non-patent document 2: Incremental Incrementally Compacting Garbage Collection (SIGPLAN Notice 22(7) pp.253 to 263)

### DISCLOSURE OF INVENTION

In order to solve the problem of the conventional art described above, an object of the present invention is to provide a memory management method, a memory management apparatus, and a recording medium which records a memory management program in which a process of generating a continuous available area can be interrupted to execute the main program.

To achieve the above object, according to one aspect of the present invention, a memory management method for providing a data recording area to record data which are used to execute a program and so on (abbreviated as the main program hereinafter) and a heap area to record data which include a data element used during operation of a main program (abbreviated as the object hereinafter) in a memory, deleting an object in the heap area which becomes unnecessary as a main program is executed, generating an available free area (abbreviated as the available area hereinafter) in the heap area, and moving an object recorded in the heap area to generate a continuous available area in the heap area, wherein the object which further includes a copy position pointer to record a position of a copy destination or copy source of an object and an object position pointer which refers to the position of the object is recorded in the data recording area, the memory management method comprises: a range setting up step of setting up a limited range to generate a continuous available area in the heap area; an object copying step of copying a copy source object included in the limited range as a copy destination object in the available area which is not included in the limited range and setting up a referential destination of a copy position pointer of the copy source object and copy destination object is set to each other's object position; a first pointer updating step of updating a referential destination of an object position pointer which refers to the position of the copy source object, which is recorded in the data recording area, to a position of a copy destination object which is copied in the object copying step; a step of making the limited range available for making the area of the limited range be an available area; a copy determination step of determining whether data is written into a recording area of the copy source object or a recording area of the copy destination object when or after the main program writes the data into a recording area of an object, which is recorded in the heap area, during the execution of the object copying step; and a copy writing step of writing data, which the main program writes, into both the recording area of the copy source object and the recording area of the copy destination object when it is determined in the copy determination step that that the data is written into either the recording area of the copy source object or the recording area of the copy destination object.

According to such a configuration, when or after the main program writes the data into the recording area of the copy source object or the recording area of the copy destination object, the data to execute the writing can be written into both the recording areas of the copy source object and the copy destination object. Consequently, data consistency can be ensured between the copy source object and the copy destination object and the process of generating the continuous available area can thereby be interrupted to make the main program execute the process. Consequently, the continuous available area can be generated in the heap area without reducing real time effectiveness in the process of the main program.

According to another aspect of the present invention, a memory management method for providing a data recording area to record data which are used to execute a program and so on (abbreviated as the main program hereinafter) and a heap area to record data which include a data element used during operation of a main program (abbreviated as the object hereinafter) in a memory, deleting an object in the heap area which becomes unnecessary as a main program is executed, generating an available free area (abbreviated as the available area hereinafter) in the heap area, and moving an object recorded in the heap area to generate a continuous available area in the heap area, wherein an object position pointer which refers to the position of the object is recorded in the data recording area, and an object position recording area which records a position of an object is further provided in the memory, the memory management method comprises: a range setting up step of setting up a limited range to generate a continuous available area in the heap area; an object copying step of copying a copy source object included in the limited range as a copy destination object in the available area which is not included in the limited range and recording a position of the copy source object and a position of the copy destination object in the object position recording area; a first pointer updating step of updating a referential destination of an object position pointer which refers to the position of the copy source object, which is recorded in the data recording area, to a position of a copy destination object which is copied in the object copying step; a step of making the limited range available for making the area of the limited range be an available area; a copy determination step of determining whether data is written into a recording area of the copy source object or a recording area of the copy destination object when or after the main program writes the data into a recording area of an object, which is recorded in the heap area, during the execution of the object copying step; and a copy writing step of writing data, which the main program writes, into both the recording area of the copy source object and the recording area of the copy destination object when it is determined in the copy determination step that data is written into either the recording area of the copy source object or the recording area of the copy destination object.

According to such a configuration, when or after the main program writes the data into the recording area of the copy source object or the recording area of the copy destination object, the main program can write the data to execute the writing into both the recording areas of the copy source data and the recording area of the copy destination data, so that the effect similar to claim 1 can be obtained. Moreover, the position of the copy source object, the position of the copy destination object, the recording area of the copy source object, and the recording area of the copy destination object can be obtained with reference to the object position recording area, so that the object does not need to have the copy position pointer. Consequently, usability of the heap area is improved.

It is preferable that in the memory management method in the above invention, the object further includes the object position pointer as the data element, the memory management method further comprises: a second pointer updating step of updating a referential destination of an object position pointer which refers to a position of the copy source object in the heap area to a position of a copy destination object which is copied in the object copying step; a referential destination changing step of changing a referential destination of the object position pointer to the position of the copy destination object when or after the main program writes an object position pointer which refers to the position of the copy source object into the heap area; an identification determination step of determining that two object position pointers refer to an identical object when one of two object position pointers refers to a position of the copy source object and also when the other object position pointer refers to a position of the copy destination object in a process of the main program determining whether the two object position pointers refer to the identical position of the object, wherein in the copy determination step, it is determined whether data is written into a recording area of the copy source object or a recording area of the copy destination object when or after the main program writes the data in the recording area of an object, which is recorded in the heap area, during the object copying step or the second pointer updating step.

According to such a configuration, when or after the main program writes the object position pointer which refers to the position of the copy source object into the heap area, the referential destination of the object position pointer can be changed to the position of the copy destination object. Consequently, the problem that there is no data in the referential destination of the object position pointer after the above process (the compaction process) can be avoided, so that the occurrence of the error during the process of the main program can be avoided and the process to generate the continuous available area can be interrupted to make the main program execute the process. Consequently, the continuous available area can be generated in the heap are without reducing real time effectiveness in the process of the main program.

It is preferable that in the memory management method according to the above invention, a stack area in which function frames, which temporarily record an execution result of a function executed by the main program and so on, are stacked in layers is provided in the data recording area, the memory management method further comprises: a third pointer updating step of scanning the function frame in the stack area from an upper toward lower of the function frame and updating a referential destination of an object position pointer which refers to a position of the copy source object, which is recorded in the stack area in order of upper to lower, to a position of a copy destination object which is copied in the object copying step; and a barrier setting up step of setting up a barrier for controlling an execution of a function to the function frame to which the third pointer updating step is executed last when an update process of an object position pointer executed in the third pointer updating step is interrupted, wherein the referential destination of the object position pointer which refers to the position of the copy source object, which is recorded in the data recording area except for the stack area, is updated to the position of the copy destination object in the first pointer updating step, and the barrier restarts the process executed in the third pointer updating step after an execution of a function is completed.

According to such a configuration, the barrier is set up to the function frame to which the update process of an object position pointer is executed last, and the barrier restarts the update process of the object position pointer after the execution of the function is completed. Consequently, the update process of the object position pointer in the stack area can be interrupted to make the main program execute the function, and the object position pointer in the stack area can be updated without reducing real time effectiveness in the process of the main program.

It is preferable that in the memory management method according to the above invention, part or all of the data recording area is allocated in the heap area and an area except for the data recording area in the heap area is determined to be the heap area described in one of claims 1 to 3, in the range setting up step, a limited range can be set up to an area to which the data recording area is allocated in the heap area, in the first pointer updating step, a referential destination of an object position pointer which refers to the position of the copy source object, which is recorded in the data recording area in the limited range, is updated to the position of the copy destination object and the data recording area in the limited range is moved to an available area in the heap area, and a referential destination of an object position pointer which refers to the position of the copy source object, which is recorded in the data recording area which is not included in the limited range, is updated to the position of the copy destination object.

According to such a configuration, the data recording area is allocated in the heap area, and the area in the heap area in which the data recording area is not included is determined to be the heap area described in one of claims 1 to 3, so that the effect similar to the invention described in one of claims 1 to 3 can be obtained.

It is preferable that in the memory management method according to the above invention, part or all of the data recording area except for the stack area is allocated in the heap area and an area except for the data recording area in the heap area is determined to the heap area described in one of claims 1 to 3, in the range setting up step, a limited range can be set up to an area to which the data recording area is allocated in the heap area, in the first pointer updating step, a referential destination of an object position pointer which refers to the position of the copy source object, which is recorded in the data recording area in the limited range, is updated to the position of the copy destination object and the data recording area in the limited range is moved to an available area in the heap area, and a referential destination of an object position pointer which refers to the position of the copy source object, which is recorded in the data recording area except for the limited range and the stack area, is updated to the position of the copy destination object.

According to such a configuration, the data recording area except for the stack area is allocated in the heap area, and the area in the heap area in which the data recording area is not included is determined to be the heap area described in one of claims 1 to 3, so that the effect similar to the invention described in one of claim 4 can be obtained.

It is preferable that in the memory management method according to the above invention, part or all of the data recording area including the stack area is allocated in the heap area and an area except for the data recording area in the heap area is determined to be the heap area described in one of claims 1 to 3, in the range setting up step, a limited range can be set up to an area to which the data recording area is allocated in the heap area, in the first pointer updating step, a referential destination of an object position pointer which refers to the position of the copy source object, which is recorded in the data recording area except for the stack range, is updated to the position of the copy destination object and the data recording area which is allocated in the limited range except for the stack area is moved to an available area in the heap area, a referential destination of an object position pointer which refers to the position of the copy source object, which is recorded in the data recording area except for the stack area which is not included in the limited range, is updated to the position of the copy destination object, in the third pointer updating step, the function frame in the stack area which is allocated in the heap area is scanned from an upper toward lower of the function frame, a referential destination of an object position pointer which refers to a position of the copy source object, which is recorded in the function frame in the limited range is updated to a position of the copy destination object, and the function frame in the limited range is moved to an available area in the heap area, a referential destination of an object position pointer which refers to a position of the copy source object, which is recorded in the function frame which is not included in the limited range, is updated to a position of the copy destination object, and in the barrier setting up step, the barrier is set up to the function frame to which the third pointer updating step is executed last when the third pointer updating step is interrupted to execute the main program.

According to such a configuration, the data recording area including the stack area is allocated in the heap area, and the area in the heap area in which the data recording area is not included is determined to be the heap area described in one of claims 1 to 3, so that the effect similar to the invention described in one of claim 4 can be obtained. Moreover, the process of moving the stack area in the limited area to the available area in the heap area can be interrupted to make the main program execute the process. Consequently, the stack area in the limited area can be moved to the available area in the heap area without reducing real time effectiveness of the main program.

According to another aspect of the present invention, a memory management apparatus for providing a data recording area to record data which are used to execute a program and so on (abbreviated as the main program hereinafter) and a heap area to record data which include a data element used during operation of a main program (abbreviated as the object hereinafter) in a memory, deleting an object in the heap area which becomes unnecessary as a main program is executed, generating an available free area (abbreviated as the available area hereinafter) in the heap area, and moving an object recorded in the heap area to generate a continuous available area in the heap area, wherein the object which further includes a copy position pointer to record a position of a copy destination or copy source of an object and an object position pointer which refers to the position of the object is recorded in the data recording area, the memory management method comprises: a range setting up means of setting up a limited range to generate a continuous available area in the heap area; an object copying means of copying a copy source object included in the limited range as a copy destination object in the available area which is not included in the limited range and setting up a referential destination of a copy position pointer of the copy source object and copy destination object is set to each other's object position; a first pointer updating means of updating a referential destination of an object position pointer which refers to the position of the copy source object, which is recorded in the data recording area, to a position of a copy destination object which is copied by the object copying means; a means of making the limited range available for making the area of the limited range be an available area; a copy determination means of determining whether data is written into a recording area of the copy source object or a recording area of the copy destination object when or after the main program writes the data into a recording area of an object, which is recorded in the heap area, during the execution of the object copying means; and a copy writing means of writing data, which the main program writes, into both the recording area of the copy source object and the recording area of the copy destination object when it is determined by the copy determination means that the data is written into either the recording area of the copy source object or the recording area of the copy destination object.

According to another aspect of the present invention, a memory management apparatus for providing a data recording area to record data which are used to execute a program and so on (abbreviated as the main program hereinafter) and a heap area to record data which include a data element used during operation of a main program (abbreviated as the object hereinafter) in a memory, deleting an object in the heap area which becomes unnecessary as a main program is executed, generating an available free area (abbreviated as the available area hereinafter) in the heap area, and moving an object recorded in the heap area to generate a continuous available area in the heap area, wherein an object position pointer which refers to the position of the object is recorded in the data recording area, and an object position recording area which records a position of an object is further provided in the memory, the memory management method comprises: a range setting up means of setting up a limited range to generate a continuous available area in the heap area; an object copying means of copying a copy source object included in the limited range as a copy destination object in the available area which is not included in the limited range and recording a position of the copy source object and a position of the copy destination object in the object position recording area; a first pointer updating means of updating a referential destination of an object position pointer which refers to the position of the copy source object, which is recorded in the data recording area, to a position of a copy destination object which is copied by the object copying means; a means of making the limited range available for making the area of the limited range be an available area; a copy determination means of determining whether data is written into a recording area of the copy source object or a recording area of the copy destination object when or after the main program writes the data into a recording area of an object, which is recorded in the heap area, during the execution of the object copying means; and a copy writing means of writing data, which the main program writes, into both the recording area of the copy source object and the recording area of the copy destination object when it is determined by the copy determination means that data is written into either the recording area of the copy source object or the recording area of the copy destination object.

It is preferable that the memory management apparatus according to the above invention, the object further includes the object position pointer as the data element, the memory management apparatus further comprises: a second pointer updating means of updating a referential destination of an object position pointer which refers to a position of the copy source object in the heap area to a position of a copy destination object which is copied by the object copying means; a referential destination changing means of changing a referential destination of the object position pointer to the position of the copy destination object when or after the main program writes an object position pointer which refers to the position of the copy source object into the heap area during the execution of the second pointer updating means; an identification determination means of determining that two object position pointers refer to an identical object when one of two object position pointers refers to a position of the copy source object and also when the other object position pointer refers to a position of the copy destination object in a process of the main program determining whether the two object position pointers refer to the identical position of the object during the execution of the second pointer updating means, wherein the copy determination means determines whether data is written into a recording area of the copy source object or a recording area of the copy destination object when or after the main program writes the data in the recording area of an object, which is recorded in the heap area, during the execution of the object copying means or the second pointer updating means.

It is preferable that in the memory management apparatus according to the above invention, a stack area in which function frames, which temporarily record an execution result of a function executed by the main program and so on, are stacked in layers is provided in the data recording area, the memory management apparatus further comprises: a third pointer updating means of scanning the function frame in the stack area from an upper toward lower of the function frame and updating a referential destination of an object position pointer which refers to a position of the copy source object, which is recorded in the stack area in order of upper to lower, to a position of a copy destination object which is copied by the object copying means; and a barrier setting up means of setting up a barrier for controlling an execution of a function to the function frame to which a process of the third pointer updating means is executed last when an update process of an object position pointer executed by the third pointer updating means is interrupted, wherein the first pointer updating means updates the referential destination of the object position pointer which refers to the position of the copy source object, which is recorded in the data recording area except for the stack area, to the position of the copy destination object, and the barrier restarts the process executed by the third pointer updating means after an execution of a function is completed.

It is preferable that in the memory management apparatus according to the above invention, part or all of the data recording area is allocated in the heap area and an area except for the data recording area in the heap area is determined to be the heap area described in one of claims 8 to 10, the range setting up means can set up a limited range to an area to which the data recording area is allocated in the heap area, the first pointer updating means updates a referential destination of an object position pointer which refers to the position of the copy source object, which is recorded in the data recording area in the limited range, to the position of the copy destination object and moves the data recording area in the limited range to an available area in the heap area, and a referential destination of an object position pointer which refers to the position of the copy source object, which is recorded in the data recording area which is not included in the limited range, to the position of the copy destination object.

It is preferable that in the memory management apparatus according to the above invention, part or all of the data recording area except for the stack area is allocated in the heap area and an area except for the data recording area in the heap area is determined to the heap area described in one of claims 8 to 10, the range setting up means can set up a limited range to an area to which the data recording area is allocated in the heap area, the first pointer updating means updates a referential destination of an object position pointer which refers to the position of the copy source object, which is recorded in the data recording area in the limited range, to the position of the copy destination object and moves the data recording area in the limited range to an available area in the heap area, and a referential destination of an object position pointer which refers to the position of the copy source object, which is recorded in the data recording area except for the limited range and the stack area, to the position of the copy destination object.

It is preferable that in the memory management method according to the above invention, part or all of the data recording area including the stack area is allocated in the heap area and an area except for the data recording area in the heap area is determined to be the heap area described in one of claims 8 to 10, the range setting up means can set up a limited range to an area to which the data recording area is allocated in the heap area, the first pointer updating means updates a referential destination of an object position pointer which refers to the position of the copy source object, which is recorded in the data recording area except for the stack range, to the position of the copy destination object and moves the data recording area which is allocated in the limited range except for the stack area to an available area in the heap area, a referential destination of an object position pointer which refers to the position of the copy source object, which is recorded in the data recording area except for the stack area which is not included in the limited range, to the position of the copy destination object, the third pointer updating means scans the function frame in the stack area which is allocated in the heap area from an upper toward lower of the function frame, updates a referential destination of an object position pointer which refers to a position of the copy source object, which is recorded in the function frame in the limited range, to a position of the copy destination object, and moves the function frame in the limited range to an available area in the heap area, a referential destination of an object position pointer which refers to a position of the copy source object, which is recorded in the function frame which is not included in the limited range, is updated to a position of the copy destination object, and the barrier setting up means sets up the barrier to the function frame to which a process of the third pointer updating means is executed last when the process of the third pointer updating means is interrupted to execute the main program.

According to another aspect of the present invention, a computer-readable recording medium which records a memory management program to make a computer execute the memory management method described in one of claims 1 to 7.

### BRIEF DESCRIPTION OF THE DRAWINGS

FIG. 1 is a block diagram showing a configuration of a mobile phone according to a first preferred embodiment of the present invention.

FIG. 2 is a block diagram showing a configuration of a flash memory of the mobile phone in FIG. 1.

FIG. 3. is a block diagram showing a configuration of a data recording area of the mobile phone in FIG. 1.

FIG. 4. is a diagram illustrating a configuration of a stack area of the mobile phone in FIG. 1.

FIG. 5. is a diagram illustrating a configuration of an object recorded in a heap area of the mobile phone in FIG. 1.

FIG. 6. is a flow chart showing a memory management procedure in the mobile phone in FIG. 1.

FIG. 7. is a flow chart showing a compaction procedure in the memory management process in FIG. 6.

FIG. 8. is a flow chart showing an update procedure of an object position pointer in the memory management process in FIG. 6.

FIGS. 9A to 9C are diagrams illustrating a compaction process in the heap area of the mobile phone in FIG. 1.

FIG. 10 is a flow chart showing a procedure to write a data during the compaction process of the heap area of the mobile phone in FIG. 1.

FIG. 11 is a flow chart showing a procedure to write the object position pointer during the compaction process of the heap area of the mobile phone in FIG. 1.

FIG. 12 is a flow chart showing an update procedure of an object position pointer in the stack area of the mobile phone in FIG. 1.

FIGS. 13A and 13B are diagrams illustrating a barrier setting process in the stack area of the mobile phone in FIG. 1.

FIG. 14 is a flow chart showing an identification determination procedure of the object position pointer of the mobile phone in FIG. 1.

FIG. 15 is a block diagram showing a configuration of a mobile phone according to a second preferred embodiment of the present invention.

FIG. 16 is a diagram showing an example of a position recording list of the mobile phone in FIG. 15.

FIG. 17 is a flow chart showing a compaction procedure of a heap area of the mobile phone in FIG. 15.

FIG. 18 is a block diagram showing a configuration of a mobile phone according to a third preferred embodiment of the present invention.

FIG. 19 is a schematic diagram showing a state of a heap area, a data recording area, and a stack area of the mobile phone in FIG. 18.

FIG. 20 is a flow chart showing a compaction procedure in the data recording area of the mobile phone in FIG. 18.

FIG. 21 is a schematic diagram showing a state of a heap area, a data recording area, and a stack area of the mobile phone according to a third preferred embodiment of the present invention.

FIG. 22 is a flow chart showing a compaction procedure in the data recording area of the mobile phone in FIG. 21.

FIG. 23 is a flow chart showing a compaction procedure in the stack area of the mobile phone in FIG. 21.

### DESCRIPTION OF THE PREFERRED EMBODIMENTS

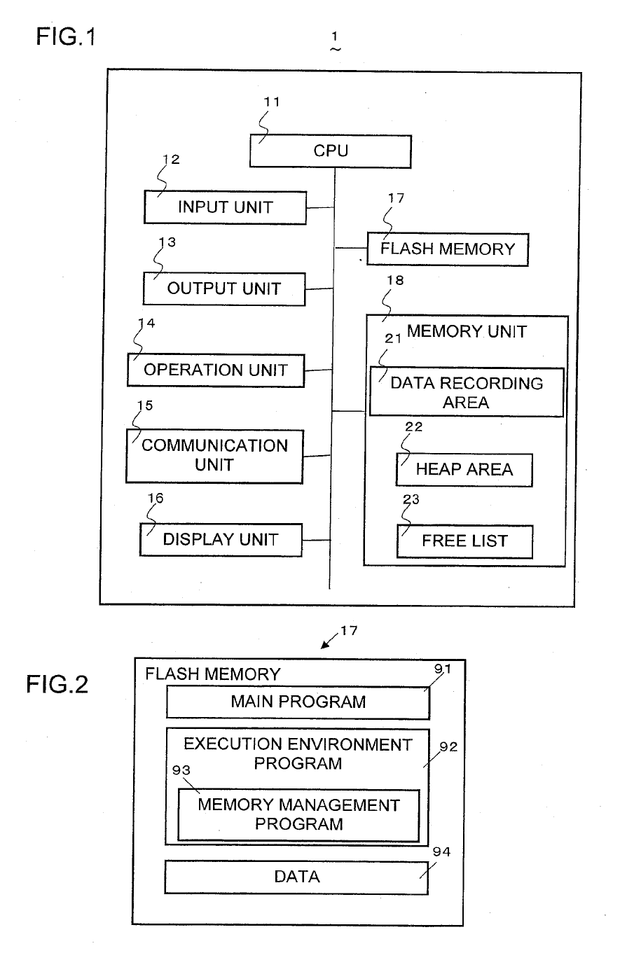

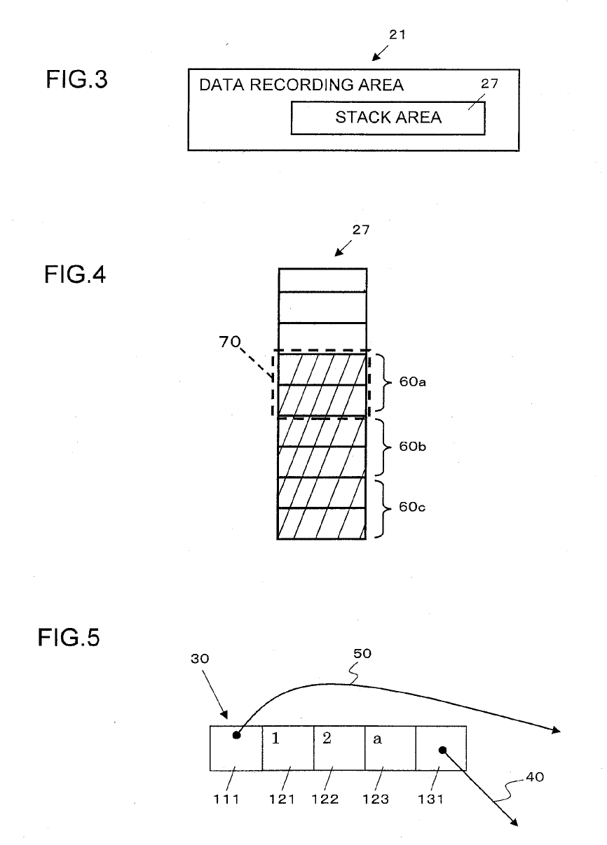

A mobile phone (a memory management apparatus) according to the first preferred embodiment of the present invention is described with reference to the drawings. The following preferred embodiment describes a case that the memory management apparatus of the present invention is applied to the mobile phone. FIG. 1 shows a configuration of a mobile phone 1, FIG. 2 shows a configuration of a flash memory (a recording medium) 17, and FIG. 3 shows a configuration of a data recording area 21. The mobile phone 1 can execute a program 91 which is created using Java language to generate a dynamic data (abbreviated as the main program 91 hereinafter) and a memory management program 93 of the present invention.

The mobile phone 1 includes an input unit 12 such as a microphone to input an audio, an output unit 13 such as a speaker to output an audio, an operation unit 14 which has keys operated by a user, a communication unit 15 which sends and receives an audio data and so on, and a display unit 16 which displays a menu, a communication situation, and so on. The mobile phone 1 also includes a flash memory 17 which records a program and data, a memory unit (memory) 18 which temporarily records a various data, and a CPU 11 which controls the various units in the mobile phone 1.

As shown in FIG. 2, the flash memory 17 records the main program 91, an execution environment program 92 such as Java VM (Java Virtual Machine) which is necessary to execute the main program 91, a memory management program 93 which is a part of the execution environment program 92, a data 94 such as various setting data, and so on. The memory management program 93 is read by the memory unit 18 and executed by the CPU 11 so that the mobile phone 1 operates as the memory management apparatus of the present invention. The memory management program 93 can be recorded in the flash memory 17 both as part of the main program 91 and the independent program.

The memory unit 18 includes a data recording area 21 to record data which are used to execute the main program 91 and so on, a heap area 22 to record data which include a data element used during the execution of the main program 91 (abbreviated as the object hereinafter), and a free list 23. The data recording area 21 records an object position pointer which refers to a position of a particular object and so on, a pointer which shows a position of a stack area 27, a fixed data recording area which records data, which shows a position where the program is executed, and so on (not shown), a temporary data recording area which records a temporary data (not shown), and so on.

The heap area 22 records the object through the execution of the main program 91, so that an available free area (abbreviated as the available area hereinafter) gradually decreases in executing the main program 91. Thus, the memory management process, which includes a garbage collection process to delete the object which becomes unnecessary as the execution of the main program 91 progresses (abbreviated as the GC hereinafter) and a compaction process to generate the continuous available area as necessary after the GC, is executed on the heap area 22 by the memory management program 93. The free list 23 records a position of the available area in the heap area 22.

Next, the configuration of the stack are 27 is described with reference to FIG. 4. FIG. 4 conceptually shows a function frame recorded in the stack area 27. The function frame is an area to record a function which is necessary for the execution of the main program 91 (referred to as “method” in Java language). In the stack are 27, function frames 60a to 60c which temporarily record an execution result of the function executed by the main program 91 and so on are stacked in layers. The function frame during execution is referred to as a current frame, and in FIG. 4, the function frame 60a is a current frame 70.

As for the function of the main program 91, an active function executes the process by calling up a function to be executed. When a function calls up other function, an invoker function reserves a new function frame by stacking the new function frame on a function frame of the active function which is reserved in the stack area 27 to execute an invokee function. After executing the invokee function, the function frame of the invoker function becomes unnecessary, so that the unnecessary function frame stacked on the function frame of the active function is destroyed. Each function frame stacked in the stack area 27 does not need to be adjacent to other function frame in the recording area in the data recording area 21.

Next, a configuration of an object recorded in the heap area 22 is described with reference FIG. 5. FIG. 5 conceptually shows an example of an object 30 recorded in the heap area 22. The object 30 is made up of a referential address 111 of a copy position pointer 50, data elements 121 to 123, and a data element 131. The data elements 121 to 123 record a numeric value, a character value, and so on, and the data element 131 records the referential address of an object position pointer 40.

The object position pointer 40 refers to other object as a data element, and the data elements 121 to 123 and the object position pointer 40 are used by the main program 91. The copy position pointer 50 records a position of the copy destination object 30 or a position of the copy source object 30. The referential address 111 of the copy position pointer 50, which is recorded at the head of the object 30, is not used by the main program 91. When the object is not copied, a particular value which indicates that “the object is not copied” is recorded in the referential address 111 of the copy position pointer 50.

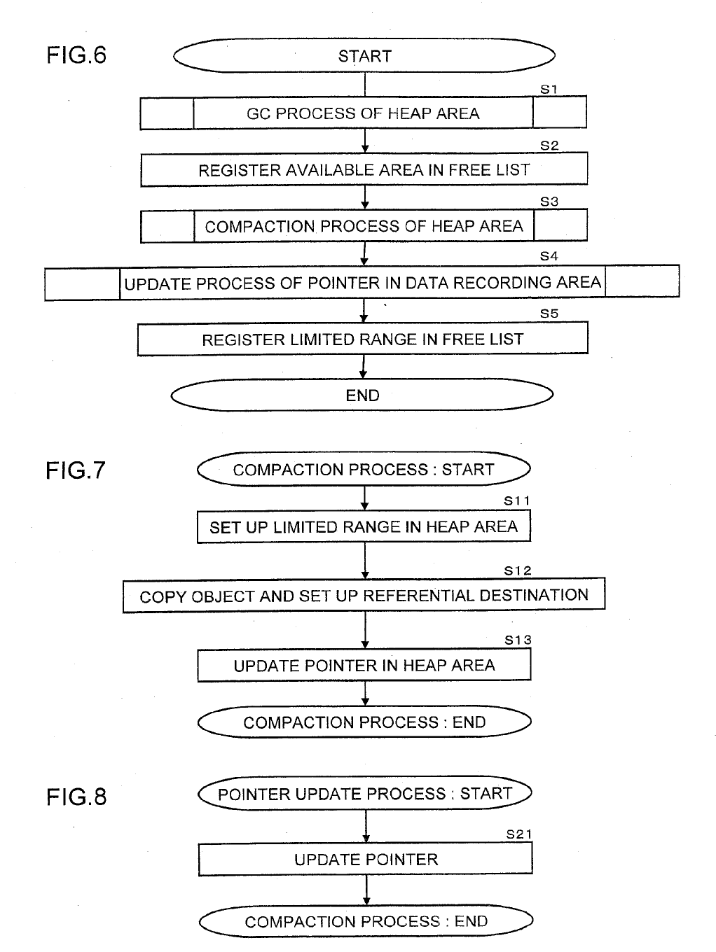

Next, the memory management process executed by the memory management program 93 is described with reference to FIG. 6. When there is insufficient available area in the heap area 22, the mobile phone 1 executes the memory management process through the execution of the memory management program 93. The mobile phone 1 determines that there is insufficient available area in the heap area 22 when the available area in the heap area 22 falls below a predetermined reference value. The reference value for determining the insufficiency of the available area in the heap area 22 is optionally configurable.

At first, the memory management program 93 executes the GC process in which the unnecessary object in the heap area 22 is deleted to generate the available area (S1), and subsequently, the memory management program 93 registers the available area of the heap area 22 in the free list 23 (S2). The GC process can be executed without reducing real time effectiveness of the main program according to the invention of Japanese Patent No. 3530887, which is achieved by the inventor of the present invention, however, the GC process can also be executed using the other method as long as it can execute the GC process without reducing real time effectiveness of the main program.

Subsequently, after the process of S2, the compaction process is executed to generate the continuous available area in the heap area 22 (S3). The details of the compaction process are described below. After the above process of S3, the memory management program 92 executes an update process of the object position pointer in the data recording area 21 (S4). The details of the update process of the object position pointer are described below. After the above process of S4, a limited range in the heap area 22 (refer to FIG. 7) is registered in the free list 23 as the continuous available area (S5: the step of making the limited range available), and the memory management process is completed.

Next, the compaction process of the above S3 is described with reference to FIG. 7. At first, the memory management program 93 sets up a limited range to generate the continuous available area in the heap area 22 (S11: the range setting up step). Subsequently, an object included in the limited range (abbreviated as the copy source object hereinafter) is copied as a copy destination object in the available area which is not included in the limited range (abbreviated as the copy destination object hereinafter), and the referential destination of the copy position pointer of the copy source object and the copy destination object is set to each other's object position (S12: the object copying step). The copy source object and the copy destination object, which are a kind of object, are described in such a way for the purpose of convenience.

Subsequently, the referential destination of the object position pointer which refers to the position of the copy source object in the heap area 22 is updated to the position of the copy destination object which is copied in the above S12 (S13: the second pointer updating step), and the compaction process is completed. In the present process, the process of the above S12 is executed after setting up the limited range in the above S11, however, the present invention is not limited to this, but the limited range can be set up during the process of the above S12. Moreover, the process of setting up the limited range in the above S11 can also be the independent program which is not included in the memory management program 93. When the process of setting up the limited range in the above S11 is the independent program, this program is executed before the memory management program 93 is executed.

Next, the update process of the object position pointer in the above S4 is described with reference to FIG. 8. The memory management program 93 updates the referential destination of the object position pointer which refers to the position of the copy source object, which is recorded in the data recording area 21, to the position of the copy destination object which is copied in the step of copying the object (S21: the first pointer updating step), and the process is completed. In the process of updating the object position pointer of the stack area 27 in the data recording area 21, the memory management program 93 scans the function frame of the stack area 27 from its upper toward lower. Subsequently, the referential destination of the object position pointer which refers to the position of the copy source object, which is recorded in the stack area 27 in order of upper to lower, is updated to the position of the copy destination object which is copied in the step of copying the object (S21: the third pointer updating step).

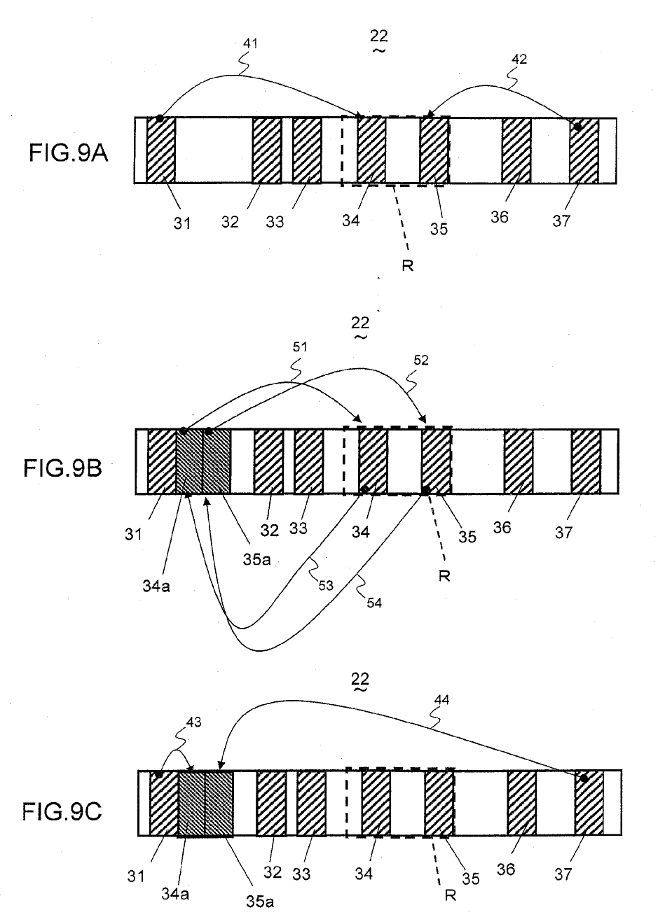

Next, a state of the heap area 22 during memory management process is described with reference to FIGS. 9A to 9C. FIGS. 9A to 9C conceptually show the state of the heap area 22 when the memory management process is executed, and FIG. 9A corresponds to the state when executing the process of the above S11, FIG. 9B corresponds to the state when executing the process of the above S12, and FIG. 9C correspond to the state when executing the process of the above S13.

In FIGS. 9A to 9C, reference numbers 31 to 37, 34a, and 35a show the object, 41 to 44 show the object position pointer, 51 to 54 show the copy position pointer, respectively, and R shows the limited range. Moreover, the reference numbers 34 and 35 show the copy source object, and 34a and 35a show the copy destination object, respectively.

As shown in FIG. 9A, the limited range R includes the copy source objects 34 and 35, the object position pointer 41 of the object 31 refers to the position of the copy source object 34, and the object position pointer 42 of the object 37 refers to the position of the copy source object 35. The objects 32 to 36 do not have the object position pointers. Moreover, the objects of the objects 31 to 37 are not copied, and the copy position pointers of the objects 31 to 37 do not refer to the positions of the other objects.

As shown in FIG. 9B, the copy source objects 34 and 35 are copied as the copy destination objects 34a and 35b in the available area in the heap area 22. At this time, the copy position pointers 51 and 53 are set up so that the copy position pointer 51 of the copy destination object 34a refers to the position of the copy source object 34 and the copy position pointer 53 of the copy source object 34 refers to the position of the copy destination object 34a. Moreover, the copy position pointers 52 and 54 are set up so that the copy position pointer 52 of the copy destination object 35a refers to the position of the copy source object 35 and the copy position pointer 54 of the copy source object 35 refers to the position of the copy destination object 35a.

When the heap area 22 is scanned and the object position pointers of the objects 31 to 37 refer to the copy source objects 34 and 35 in the limited range R, the referential destination of the objects are updated to the positions of the copy destination objects 34a and 35a. In the present preferred embodiment, as shown in FIG. 9C, the referential destination of the object position pointer 43 of the object 31 is updated to the position of the copy destination object 34a, and the referential destination of the object position pointer 44 of the object 37 is updated to the position of the copy destination object 35a.

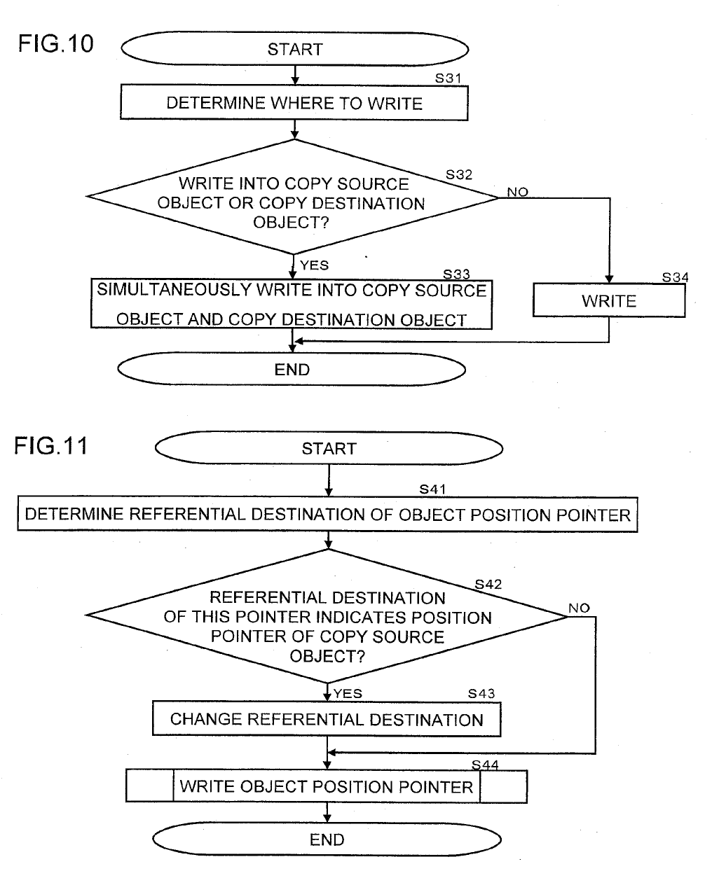

Next, the process of the main program 91 which writes data into the heap area 22 during the compaction processes in the above S 12 and S13 is described with reference to FIG. 10. At first, when or after the main program 91 writes the data into the heap area 22, the memory management program 93 determines whether the data is written into the recording area of the copy source object or the recording area of the copy destination object (S31: the copy determination step). When the data is written into either the recording area of the copy source object or the recording area of the copy destination object (Yes in S32), the memory management program 93 writes the data, which the main program 91 writes, into both the recording area of the copy source object and the recording area of the copy destination object (S33: the copy writing step).

In contrast, when it is determined in the above S31 that the data is written into neither the recording area of the copy source object nor the recording area of the copy destination object (No in S32), the memory management program 93 does not execute the process of the above S33, but the main program 91 writes the data (S34). The processes of the above S31 to S33 can also be executed in the following way. After the main program 91 executes the process of writing the data in the recording area of the object recorded in the heap area 22, the main management program 93 determines whether the data is written into either the recording area of the copy source object or the recording area of the copy destination object (corresponding to the above S31), and as a result of the determination, when the data is written (corresponding to Yes in the above S32), the memory management program 93 writes the data, which is written by the main program 91, into either the recording area of the copy source object or the recording area of the copy destination object in which the data is not written (corresponding to the above S33).

Next, the process of the main program 91 which writes the object position pointer to refer to the position of the copy source object into the heap area 22 during the compaction process in the above S13 is described with reference to FIG. 11. At first, when or after the main program 91 writes the object position pointer into the heap area 22, the memory management program 93 determines whether the referential destination of the object position pointer indicates the position of the copy source object or not (S41). When the referential destination of the object position pointer indicates the position of the copy source object of the heap area 22 (Yes in S42), the memory management program 93 changes the referential destination of the object position pointer to indicate the position of the copy source object (S43) and writes the object position pointer whose referential destination is changed according to the procedure of the above FIG. 10 (S44). At this time, the object position pointer whose referential destination is changed corresponds to the data in process of writing in the above FIG. 10.

In contrast, when it is determined in the above S41 that the referential destination of the object position pointer does not indicate the position of the copy source object (No in S42), the memory management program 93 does not execute the process of the above S43, but the main program 91 writes the object position pointer in the heap area 22 according to the procedure of the above FIG. 10 (S44). The processes of FIGS. 10 and 11 can also be executed by the main program 91 or the execution environment program 92.

As described above, when or after the main program 91 writes the data into the recording area of the copy source object or the recording area of the copy destination object, the mobile phone 1 can write the data to execute the writing into both the recording areas of the copy source object and the copy destination object. Consequently, data consistency can be ensured between the copy source object and the copy destination object. The copy process of the object can thereby be interrupted to make the main program 91 execute the above process.

When or after the main program 91 writes the object position pointer which refers to the position of the copy source object into the heap area 22, the mobile phone 1 can change the referential destination of the object position pointer to the position of the copy destination object. Consequently, the problem that there is no data in the referential destination of the object position pointer can be avoided, so that the occurrence of the error during the process of the main program 91 can be avoided. The mobile phone 1 can thereby interrupt the compaction process to execute the process of the main program 91 and can generate the continuous available area in the heap are 22 without reducing real time effectiveness in the process of the main program 91.

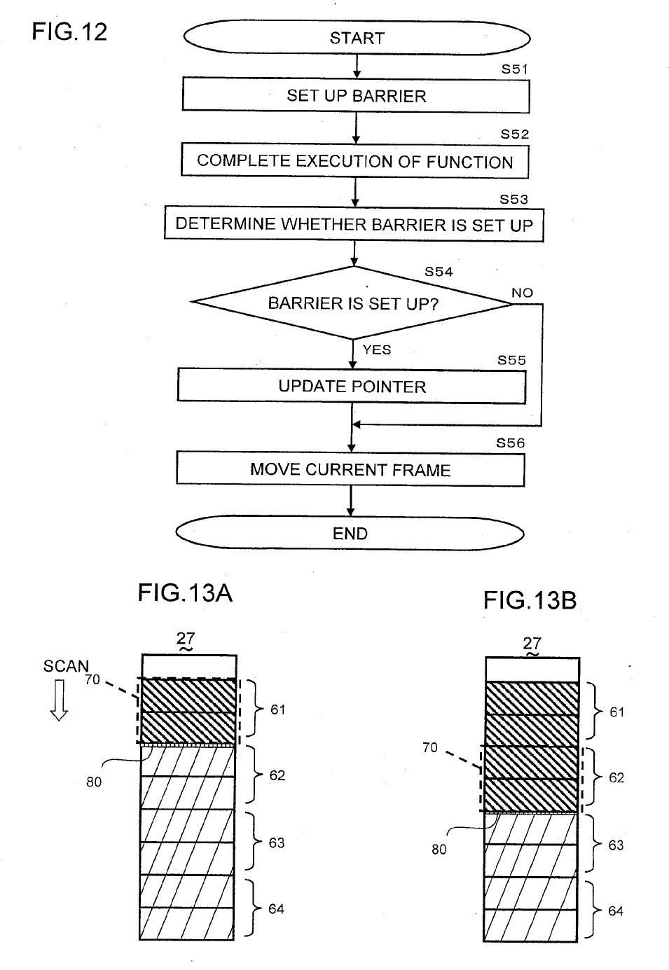

Next, the process of the main program 91 which executes the function during the process of the above S21, that is, the update process of the above object position pointer to the stack area 27 is described with reference to FIG. 12. At first, when the memory management program 93 interrupts the update process of the object position pointer, the memory management program 93 sets up a barrier for controlling the execution of the function to the function frame to which the update process of the object position pointer is executed last (S51: the barrier setting up step). When the execution of the function executed by the main program 91 is completed and the function frame is destroyed (S52), the main program 91 determines whether the barrier is set up to the function frame (S53).

As a result of the above S53, when the barrier is set up (Yes in S54), the barrier restarts the update process of the object position pointer in the stack area 27 which is executed by the memory management program 93, and the memory management program 93 updates the referential destination of the object position pointer which refers to the copy source object in the function frame, which is located in the lower of the function frame, to the position of the copy destination object (S55). Subsequently, the memory management program 93 sets up again the barrier for controlling the execution of the function to the function frame to which the update process of the object position pointer is executed last, moves the current frame to the lower function frame, and executes the function of the function frame to which the current frame is moved.

In contrast, when the barrier is not set up to the function frame in the above S53 (No in S54), the memory management program 93 does not executes the process of the above S55 but executes the process of the above S56. The above process of setting up the barrier and determining whether or not the barrier is set up can also be executed by the execution environment program 92. Moreover, when the object position pointer of the stack area 27 is updated through the above process, the update process of the object position pointer described in FIG. 8 is executed to the data recording area 21 except for the stack area 27.

Next, the stack area 27 during the process of the object position pointer described in FIG. 12 is described with reference to FIGS. 13A and 13B. FIGS. 13A and 13B conceptually show the stack area 27, and FIG. 13A corresponds to the process of the above S52 and FIG. 13B corresponds to the process of the above S56. In FIGS. 13A and 13B, reference numbers 61 to 64 show the function frames, 70 shows the current frame, and 80 shows the barrier.

As shown in FIG. 13A, the current frame 70 is located in the function frame 61, and at this time, the object position pointer of the function frame 61 is already updated. The execution of the function of the function frame 61 is completed, the memory management program 93 executes the update process of the object position pointer of the function frame 62 according to the setup barrier 80. After the update process of the object position pointer of the function frame 62, as shown in FIG. 13B, the memory management program 93 sets up the barrier 80 to the function frame 62 and moves the current frame 70 to the function frame 62, and the main program 91 executes the function of the function frame 62. In the above S55, the plural object position pointers of the function frames can also be updated.

As described above, the mobile phone 1 sets up the barrier to the function frame to which the update process of the object position pointer is executed last, and after the execution of the function is completed, the barrier restarts the update process of the object position pointer. The mobile phone 1 can thereby interrupt the update process of the object position pointer and can execute the function which is executed by the main program, so that the object position pointer in the stack area can be updated without reducing real time effectiveness in the process of the function executed by the main program 91. The update process of the object position pointer in the stack area 27 can be executed separately, so that real time effectiveness in the process of the main program 91 is not reduced.

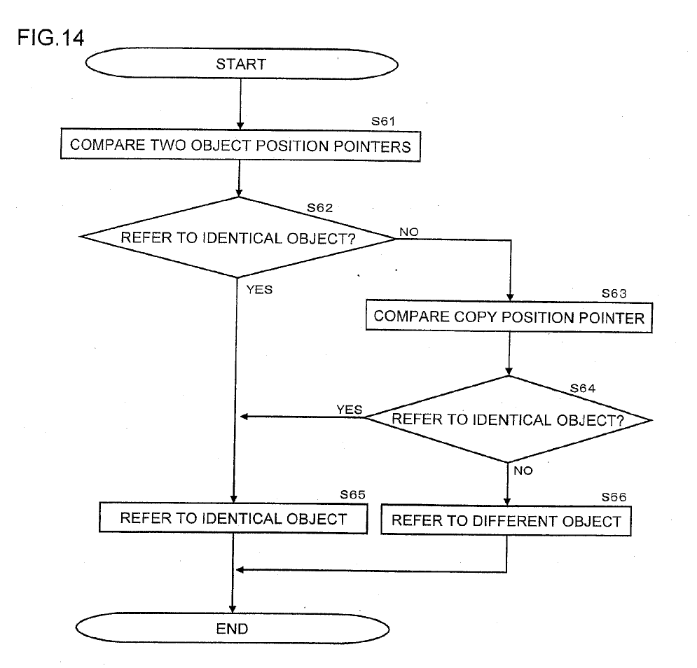

Next, a comparison process of the two object position pointers during the compaction process of the above S13 is described with reference to FIG. 14. Here, the main program 91 has the two object position pointers by executing a readout process from the heap area 22, for example. At first, the main program 91 compares the two object position pointers (S61), and when they refers to the identical object (Yes in S62), the main program 91 determines that they refers to the identical object (S65) and completes the identification determination process.

In contrast, when they do not refer to the identical object (No in S62), the main program 91 compares the copy position pointer of the object which is referred to by one object position pointer with the other object position pointer (S63). When these two pointers refer to the identical object (Yes in S64), the main program 91 executes the determination of the above S65 and completes the identification determination process. When these two pointers do not refer to the identical object in the above S63 (No in S64), the main program 91 determines that they refer to the different object (S66) and completes the identification determination process. The process shown in the above FIG. 14 can also be executed by the execution environment program 92.

As a result of the above S61, when one of two object position pointers refers to the position of the copy source object and also when the other object position pointer refers to the position of the copy destination object (Yes in S62), the memory management program 93 determines that the two object position pointers refer to the identical object (S63: the identification determination step) and completes the process. In contrast, as a result of the above S61, when one of two object position pointers does not refer to the position of the copy source object and also when the other object position pointer does not refer to the position of the copy destination object (No in S62), the memory management program 93 completes the process without executing the process of the above S63. Accordingly, the mobile phone 1 can determine whether or not the two object position pointers refer to the identical object.

As described above, according to the mobile phone 1 of the present preferred embodiment, the process of generating the continuous available area in the heap area 22 can be interrupted to make the main program 91 execute the process, so that real time effectiveness in the process of the main program 91 is not reduced. Consequently, a developer does not need to set up a timing for executing the memory management program 93 mandatorily according to the size of the memory unit 18 included in various types of the mobile phones in a conventional manner, so that the development is efficiently promoted and the development period can be shortened.

When the main program 91 writes the data and the object position pointer into the heap area 22, a process for determining the recording area to write the data and the object position pointer and the referential destination of the object position pointer is added. Generally, the main program 91 executes the readout process to the heap area 22 more frequently than the writing process, so that overhead in executing the main program 91 is smaller compared to the case that the process is added when reading out the object from the heap area 22.

Moreover, the limited range can be set up after the GC process is executed, so that the limited range can be set up in view of various factors such as the available area, the amount of the used data, and so on, and the available area can be generated effectively.

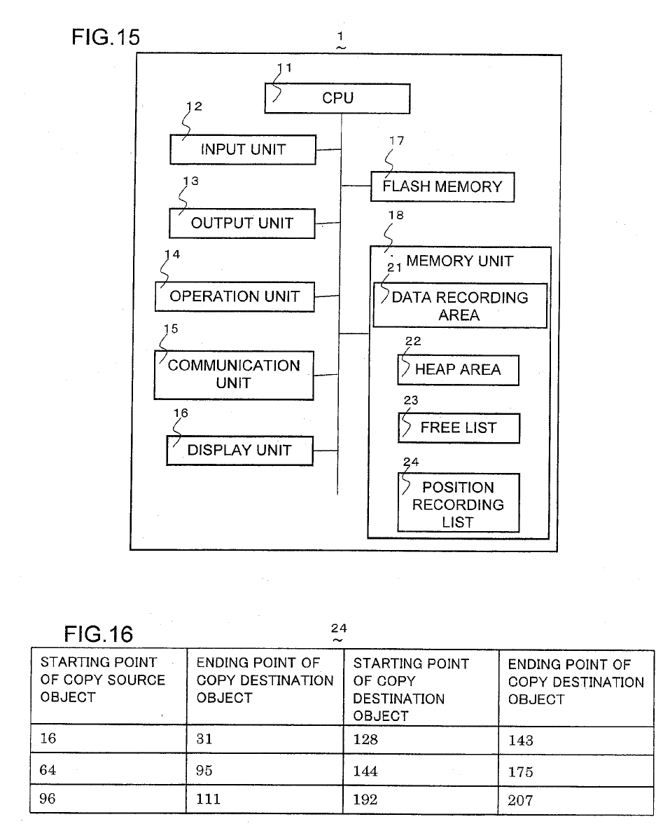

Next, a mobile phone according to the second preferred embodiment of the present invention is described with reference to FIG. 15. FIG. 15 shows a configuration of a mobile phone 1 of the present preferred embodiment. The mobile phone 1 has the configuration similar to that described in the first preferred embodiment except that the memory unit 18 further has a position recording list (the object position recording area) 24 and the object recorded in the heap area 22 does not include the copy position pointer. The position recording list 24 is a list to record the position of the object in the heap area 22 which corresponds to the copy position pointer in the first preferred embodiment. The object recorded in the heap area 22 is made up of the data element and the object position pointer.

Next, the position recording list 24 is described with reference to FIG. 16. FIG. 16 shows an example of the position recording list 24 which records the position of the copy source object and copy destination object. As shown in FIG. 16, the position recording list 24 records the adjacent plural copy source objects as a copy source object group and the adjacent plural copy destination objects as a copy destination object group collectively, and positions of a starting point and an ending point of the copy source object group and positions of a starting point and an ending point of the copy destination object group which corresponds to the copy source object group are numerically recorded to indicate an address in the heap area 22. Memory management program 93 thereby refers to the position recording list 24 when obtaining the position of the copy source object, the position of the copy destination object, the recording area of the copy source object, or the recording area of the copy destination object.

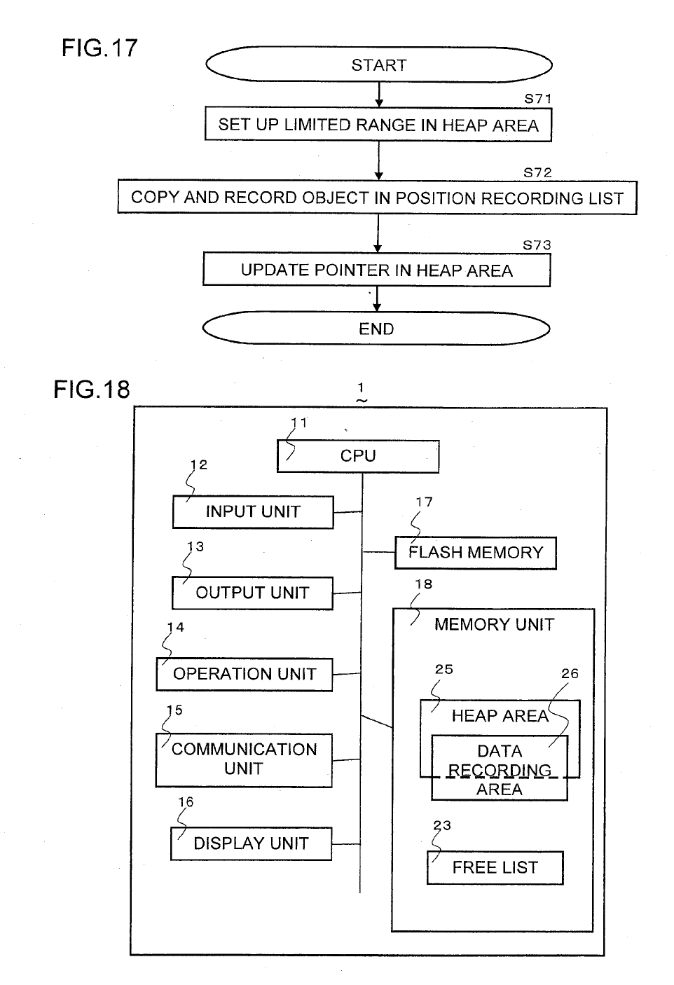

Next, a compaction process of the mobile phone 1 is described with reference to FIG. 17. At first, the memory management program 93 sets up a limited range to generate the continuous available area in the heap area 22 (S71). Subsequently, the memory management program 93 copies the copy source object included in the limited range as the copy destination object in the available are which is not included in the limited range and records the position of the copy source object and copy destination object in the position recording list 24 (S72).

The memory management program 93 refers to the position recording list 24 and updates the referential destination of the object position pointer which refers to the position of the copy source object in the heap area 22 to the position of the copy destination object which is copied in the above S72 (S73), and the compaction process of the heap area 22 is completed.

As described above, according to the mobile phone 1 of the present preferred embodiment, an effect similar to the mobile phone of the first preferred embodiment can be obtained. Moreover, the position of the copy source object, the position of the copy destination object, the recording area of the copy source object, and the recording area of the copy destination object can be obtained with reference to the position recording list 24, so that the object does not need to have the copy position pointer. Consequently, usability of the heap area 22 is improved.

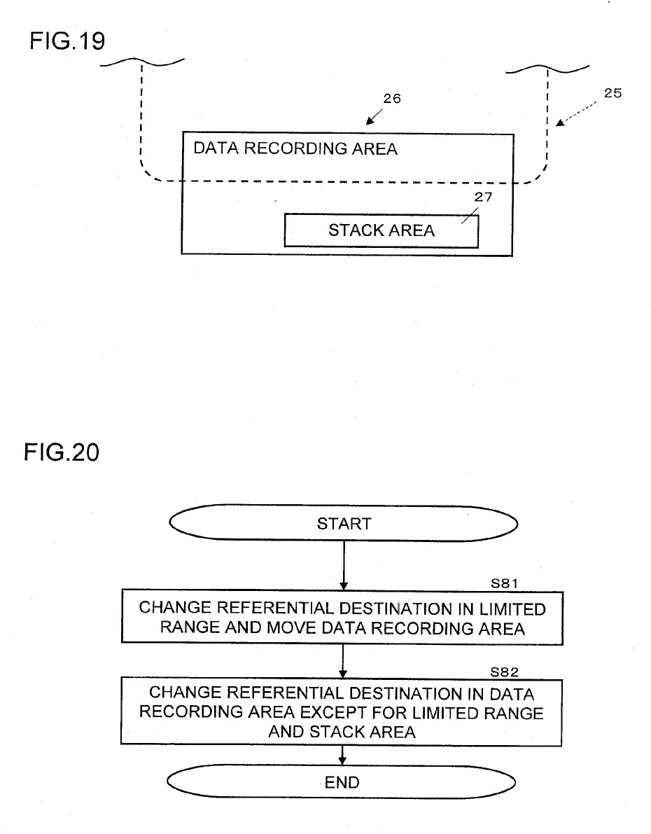

Next, a mobile phone according to the third preferred embodiment of the present invention is described with reference to FIGS. 18 and 19. FIG. 18 shows a configuration of a mobile phone 1 of the present preferred embodiment, and FIG. 19 shows an allocation of the data recording area 26 in a heap area 25. The mobile phone 1 has the configuration similar to that described in the first preferred embodiment except that part of the data recording area 26 is allocated in the heap area 25. As shown in FIG. 19, the stack area 27 is not allocated in the heap area 25.

The mobile phone 1 can make the area of the heap area 25 except for the data recording area 26 be the heap area of the mobile phone according to the first preferred embodiment. The memory management program 93 can set up the limited range to the area where the data recording area 26 is allocated in the heap area 25.

Next, the compaction process of the data recording area 26 in the limited range which is executed by the memory management program 93 is described with reference to FIG. 20. At first, the memory management program 93 updates the referential destination of the object position pointer which refers to the position of the copy source object, which is recorded in the data recording area 26 in the limited range, to the position of the copy destination object and moves the data recording area 26 in the limited range to the available area in the heap area 25 (S81).

Subsequently, the memory management program 93 updates the referential destination of the object position pointer which refers to the position of the copy source object, which is recorded in the data recording area 26 except for the limited range and the stack area 27, to the position of the copy destination object (S82) and completes the process. Consequently, the compaction process can also be executed to the data recording area 26 which is allocated to the heap area 25, and the continuous available area can be generated in the heap area 25 effectively.

As described above, according to the mobile phone 1 of the present preferred embodiment, even when part of the data recording area 26 is allocated to the heap area 25, the effect similar to the mobile phone of the first preferred embodiment can be obtained. In the present preferred embodiment, part of the data recording area 26 is allocated to the heap area 25, however, all of the data recording area 26 except for the stack area 27 can also be allocated to the heap area 25. Even in this case, the mobile phone 1 can obtain the effect similar to the mobile phone of the first preferred embodiment.

Moreover, when the memory unit 18 of the mobile phone 1 according to the present preferred embodiment further has the position recording list 24 to record the position of the object and when the object recorded in the heap area 25 does not have the copy position pointer, the mobile phone 1 of the present preferred embodiment can obtain the effect similar to the mobile phone of the second preferred embodiment.

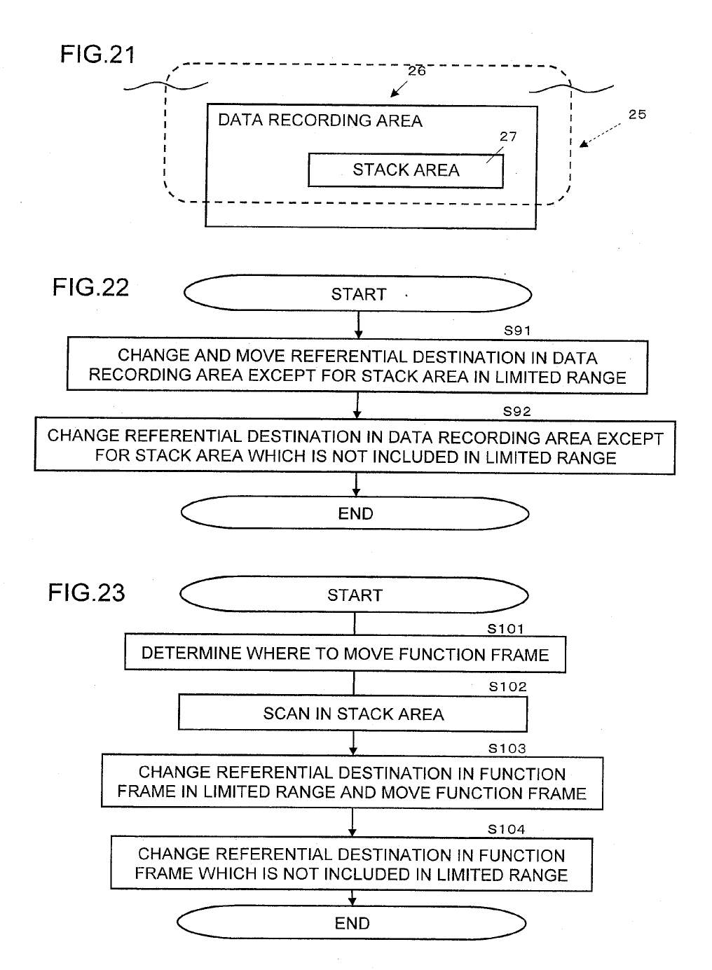

Next, a mobile phone according to the fourth preferred embodiment of the present invention is described with reference to FIG. 21. FIG. 21 shows an allocation of the data recording area 26 in the heap area 25. The mobile phone 1 has the configuration similar to that described in the third preferred embodiment except that part of the data recording area 26 is allocated in the heap area 25 and the stack area 27 is allocated in the heap area 25.

Next, the compaction process of the data recording area 26 in the limited range which is executed by the memory management program 93 is described with reference to FIG. 22. At first, the memory management program 93 updates the referential destination of the object position pointer which refers to the position of the copy source object, which is recorded in the data recording area 26 except for the stack area 27 in the limited range, to the position of the copy destination object and moves the data recording area 26 allocated in the limited range except for the stack area 27 to the available area in the heap area 25 (S91).

Subsequently, the memory management program 93 updates the referential destination of the object position pointer which refers to the position of the copy source object, which is recorded in the data recording area 26 except for the stack area 27 which is not included in the limited range, to the position of the copy destination object (S92) and completes the process. Consequently, the compaction process can also be executed to the data recording area 26 which is allocated to the heap area 25 except for the stack area 27, and the continuous available area can be generated in the heap area 25 effectively.

Next, the compaction process of the stack area 27 in the limited range which is executed by the memory management program 93 is described with reference to FIG. 23. At first, the memory management program 93 determines where to move the function frame in the limited range (S101) and scans the function frame of the stack area 27 allocated in the heap area 25 from its upper toward lower (S102). Subsequently, the memory management program 93 updates the referential destination of the object position pointer which refers to the position of the copy source object, which is recorded in the function frame in the limited range, to the position of the copy destination object and moves the function frame in the limited range to the available area in the heap area 25 (S103).

Subsequently, the memory management program 93 updates the referential destination of the object position pointer which refers to the position of the copy source object, which is recorded in the function frame which is not included in the limited range, to the position of the copy destination object (S104) and completes the process. Consequently, the compaction process can also be executed to the stack area 27 in the heap area 25, and the continuous available area can be generated in the heap area 25 effectively.

As described above, according to the mobile phone 1 of the present preferred embodiment, even when the stack area 27 is allocated in the heap area 25, the effect similar to the mobile phone of the third preferred embodiment can be obtained. In the present preferred embodiment, part of the data recording area 26 is allocated to the heap area 26, however, all of the data recording area 26 can also be allocated to the heap area 26. Even in this case, the mobile phone 1 can obtain the effect similar to the mobile phone of the third preferred embodiment. Moreover, even when part of the stack area 27 is allocated to the area which is not included in the heap area 25, the mobile phone 1 can obtains the effect similar to the mobile phone of the third preferred embodiment.

Next, an experimental result of a maximum outage time of the main program in case of executing the memory management program 93 on a computer is described below. The computer used in the present experiment has a CPU of “Xeon 3.2 GHz” and a memory of 1 GB. The maximum outage time of the main program executed by the memory management program 93 is measured on the basis that the computer mounts Java execution environment having a heap area of 5 MB and Boyer benchmark is executed on JAKLD (Java Application Kumikomi Lisp Driver: LISP processing system: refer to Journal of Information Processing Society of Japan, “Programming” Vol. 44, pp. 1 to 16). The GC process suggested by the inventor of the present invention in Japanese Patent No. 3,530,887 is used in the memory management program 93. Moreover, in the present experiment, the data recording area and the stack area are allocated in the heap area.

At first, in case of the conventional method that the compaction process is executed all at once, the maximum outage time of the main program is measured to be 9.5 ms. In contrast, the maximum outage time of the memory management program 93 according to the present invention is measured to be 0.7 ms.

The present invention is not limited to the configuration of the above preferred embodiment, however, various modification are applicable within the scope of the invention. For example, in the above preferred embodiments, the memory management apparatus is applied to the mobile phone, however, it can also be applied to the computer, for example. Moreover, in the mobile phone 1 of the above preferred embodiments, the memory management program 93 is recorded in the flash memory 17, however, the memory management program 93 can also be recorded in the other recording medium, and moreover, it is also possible to make the mobile phone execute the memory management program 93 which is downloaded from the Internet by using the communication unit 15. Furthermore, the memory management program 93 can also execute the process to the register by using the register in the CPU 11 as the data area.

The memory management program 93 can further change the reference destination of the object position pointer to the position of the copy destination pointer when or after the main program 91 writes the object position pointer which refers to the position of the copy source object into the data recording area during the process of updating the referential destination of the object position pointer which refers to the position of the copy source object, which is recorded in the data recording area, to the position of the copy destination object. Furthermore, the memory management program 93 can also change the reference destination of the object position pointer to the position of the copy destination pointer when or after the main program 91 writes the object position pointer which refers to the position of the copy source object into the heap area.

The present invention is based on Japanese Patent Application No. 2007-026111, and as a result, the subject matter is to be combined with the present invention with reference to the specification and drawings of the above patent application.

Although the present invention is fully described by the preferred embodiments with reference to the accompanying drawings, it is clear to the person having ordinary skill in the art that the various changes and modifications are applicable. Consequently, such changes and modifications do not depart from the scope of the present invention but are to be included in the scope of the present invention.

1. A memory management method for providing a data recording area to record data which are used to execute a program and so on (abbreviated as the main program hereinafter) and a heap area to record data which include a data element used during operation of a main program (abbreviated as the object hereinafter) in a memory,
deleting an object in the heap area which becomes unnecessary as a main program is executed, generating an available free area (abbreviated as the available area hereinafter) in the heap area, and moving an object recorded in the heap area to generate a continuous available area in the heap area, wherein
the object which further includes a copy position pointer to record a position of a copy destination or copy source of an object and
an object position pointer which refers to the position of the object is recorded in the data recording area, the memory management method comprising:
a range setting up step of setting up a limited range to generate a continuous available area in the heap area;
an object copying step of copying a copy source object included in the limited range as a copy destination object in the available area which is not included in the limited range and setting up a referential destination of a copy position pointer of the copy source object and copy destination object is set to each other's object position;
a first pointer updating step of updating a referential destination of an object position pointer which refers to the position of the copy source object, which is recorded in the data recording area, to a position of a copy destination object which is copied in the object copying step;
a step of making the limited range available for making the area of the limited range be an available area;
a copy determination step of determining whether data is written into a recording area of the copy source object or a recording area of the copy destination object when or after the main program writes the data into a recording area of an object, which is recorded in the heap area, during the execution of the object copying step; and
a copy writing step of writing data, which the main program writes, into both the recording area of the copy source object and the recording area of the copy destination object when it is determined in the copy determination step that that the data is written into either the recording area of the copy source object or the recording area of the copy destination object.

2. A memory management method for providing a data recording area to record data which are used to execute a program and so on (abbreviated as the main program hereinafter) and a heap area to record data which include a data element used during operation of a main program (abbreviated as the object hereinafter) in a memory,
deleting an object in the heap area which becomes unnecessary as a main program is executed, generating an available free area (abbreviated as the available area hereinafter) in the heap area, and moving an object recorded in the heap area to generate a continuous available area in the heap area, wherein
an object position pointer which refers to the position of the object is recorded in the data recording area, and
an object position recording area which records a position of an object is further provided in the memory, the memory management method comprising:
a range setting up step of setting up a limited range to generate a continuous available area in the heap area;
an object copying step of copying a copy source object included in the limited range as a copy destination object in the available area which is not included in the limited range and recording a position of the copy source object and a position of the copy destination object in the object position recording area;
a first pointer updating step of updating a referential destination of an object position pointer which refers to the position of the copy source object, which is recorded in the data recording area, to a position of a copy destination object which is copied in the object copying step;
a step of making the limited range available for making the area of the limited range be an available area;
a copy determination step of determining whether data is written into a recording area of the copy source object or a recording area of the copy destination object when or after the main program writes the data into a recording area of an object, which is recorded in the heap area, during the execution of the object copying step; and
a copy writing step of writing data, which the main program writes, into both the recording area of the copy source object and the recording area of the copy destination object when it is determined in the copy determination step that data is written into either the recording area of the copy source object or the recording area of the copy destination object.

3. The memory management method according to claim 1, wherein the object further includes the object position pointer as the data element, further comprising:
a second pointer updating step of updating a referential destination of an object position pointer which refers to a position of the copy source object in the heap area to a position of a copy destination object which is copied in the object copying step;
a referential destination changing step of changing a referential destination of the object position pointer to the position of the copy destination object when or after the main program writes an object position pointer which refers to the position of the copy source object into the heap area;
an identification determination step of determining that two object position pointers refer to an identical object when one of two object position pointers refers to a position of the copy source object and also when the other object position pointer refers to a position of the copy destination object in a process of the main program determining whether the two object position pointers refer to the identical position of the object, wherein
in the copy determination step, it is determined whether data is written into a recording area of the copy source object or a recording area of the copy destination object when or after the main program writes the data in the recording area of an object, which is recorded in the heap area, during the object copying step or the second pointer updating step.

4. The memory management method according to claim 1, wherein a stack area in which function frames, which temporarily record an execution result of a function executed by the main program and so on, are stacked in layers is provided in the data recording area, further comprising:
a third pointer updating step of scanning the function frame in the stack area from an upper toward lower of the function frame and updating a referential destination of an object position pointer which refers to a position of the copy source object, which is recorded in the stack area in order of upper to lower, to a position of a copy destination object which is copied in the object copying step; and
a barrier setting up step of setting up a barrier for controlling an execution of a function to the function frame to which the third pointer updating step is executed last when an update process of an object position pointer executed in the third pointer updating step is interrupted, wherein
the referential destination of the object position pointer which refers to the position of the copy source object, which is recorded in the data recording area except for the stack area, is updated to the position of the copy destination object in the first pointer updating step, and
the barrier restarts the process executed in the third pointer updating step after an execution of a function is completed.

5. The memory management method according to claim 1, wherein
part or all of the data recording area is allocated in the heap area and an area except for the data recording area in the heap area is determined to be the heap area,
in the range setting up step, a limited range can be set up to an area to which the data recording area is allocated in the heap area,
in the first pointer updating step, a referential destination of an object position pointer which refers to the position of the copy source object, which is recorded in the data recording area in the limited range, is updated to the position of the copy destination object and the data recording area in the limited range is moved to an available area in the heap area, and
a referential destination of an object position pointer which refers to the position of the copy source object, which is recorded in the data recording area which is not included in the limited range, is updated to the position of the copy destination object.

6. The memory management method according to claim 4, wherein
part or all of the data recording area except for the stack area is allocated in the heap area and an area except for the data recording area in the heap area is determined to be the heap area,
in the range setting up step, a limited range can be set up to an area to which the data recording area is allocated in the heap area,
in the first pointer updating step, a referential destination of an object position pointer which refers to the position of the copy source object, which is recorded in the data recording area in the limited range, is updated to the position of the copy destination object and the data recording area in the limited range is moved to an available area in the heap area, and
a referential destination of an object position pointer which refers to the position of the copy source object, which is recorded in the data recording area except for the limited range and the stack area, is updated to the position of the copy destination object.

7. The memory management method according to claim 4, wherein
part or all of the data recording area including the stack area is allocated in the heap area and an area except for the data recording area in the heap area is determined to be the heap area,
in the range setting up step, a limited range can be set up to an area to which the data recording area is allocated in the heap area,
in the first pointer updating step, a referential destination of an object position pointer which refers to the position of the copy source object, which is recorded in the data recording area except for the stack range, is updated to the position of the copy destination object and the data recording area which is allocated in the limited range except for the stack area is moved to an available area in the heap area,
a referential destination of an object position pointer which refers to the position of the copy source object, which is recorded in the data recording area except for the stack area which is not included in the limited range, is updated to the position of the copy destination object,
in the third pointer updating step, the function frame in the stack area which is allocated in the heap area is scanned from an upper toward lower of the function frame, a referential destination of an object position pointer which refers to a position of the copy source object, which is recorded in the function frame in the limited range is updated to a position of the copy destination object, and the function frame in the limited range is moved to an available area in the heap area,
a referential destination of an object position pointer which refers to a position of the copy source object, which is recorded in the function frame which is not included in the limited range, is updated to a position of the copy destination object, and
in the barrier setting up step, the barrier is set up to the function frame to which the third pointer updating step is executed last when the third pointer updating step is interrupted to execute the main program.

8. A memory management apparatus for providing a data recording area to record data which are used to execute a program and so on (abbreviated as the main program hereinafter) and a heap area to record data which include a data element used during operation of a main program (abbreviated as the object hereinafter) in a memory,
deleting an object in the heap area which becomes unnecessary as a main program is executed, generating an available free area (abbreviated as the available area hereinafter) in the heap area, and moving an object recorded in the heap area to generate a continuous available area in the heap area, wherein
the object which further includes a copy position pointer to record a position of a copy destination or copy source of an object and
an object position pointer which refers to the position of the object is recorded in the data recording area, the memory management method comprising:
a range setting up means of setting up a limited range to generate a continuous available area in the heap area;
an object copying means of copying a copy source object included in the limited range as a copy destination object in the available area which is not included in the limited range and setting up a referential destination of a copy position pointer of the copy source object and copy destination object is set to each other's object position;
a first pointer updating means of updating a referential destination of an object position pointer which refers to the position of the copy source object, which is recorded in the data recording area, to a position of a copy destination object which is copied by the object copying means;
a means of making the limited range available for making the area of the limited range be an available area;
a copy determination means of determining whether data is written into a recording area of the copy source object or a recording area of the copy destination object when or after the main program writes the data into a recording area of an object, which is recorded in the heap area, during the execution of the object copying means; and
a copy writing means of writing data, which the main program writes, into both the recording area of the copy source object and the recording area of the copy destination object when it is determined by the copy determination means that the data is written into either the recording area of the copy source object or the recording area of the copy destination object.

9. A memory management apparatus for providing a data recording area to record data which are used to execute a program and so on (abbreviated as the main program hereinafter) and a heap area to record data which include a data element used during operation of a main program (abbreviated as the object hereinafter) in a memory,
deleting an object in the heap area which becomes unnecessary as a main program is executed, generating an available free area (abbreviated as the available area hereinafter) in the heap area, and moving an object recorded in the heap area to generate a continuous available area in the heap area, wherein
an object position pointer which refers to the position of the object is recorded in the data recording area, and
an object position recording area which records a position of an object is further provided in the memory, the memory management method comprising:
a range setting up means of setting up a limited range to generate a continuous available area in the heap area;
an object copying means of copying a copy source object included in the limited range as a copy destination object in the available area which is not included in the limited range and recording a position of the copy source object and a position of the copy destination object in the object position recording area;
a first pointer updating means of updating a referential destination of an object position pointer which refers to the position of the copy source object, which is recorded in the data recording area, to a position of a copy destination object which is copied by the object copying means;
a means of making the limited range available for making the area of the limited range be an available area;
a copy determination means of determining whether data is written into a recording area of the copy source object or a recording area of the copy destination object when or after the main program writes the data into a recording area of an object, which is recorded in the heap area, during the execution of the object copying means; and
a copy writing means of writing data, which the main program writes, into both the recording area of the copy source object and the recording area of the copy destination object when it is determined by the copy determination means that data is written into either the recording area of the copy source object or the recording area of the copy destination object.

10. The memory management apparatus according to claim 8, wherein the object further includes the object position pointer as the data element, further comprising:
a second pointer updating means of updating a referential destination of an object position pointer which refers to a position of the copy source object in the heap area to a position of a copy destination object which is copied by the object copying means;
a referential destination changing means of changing a referential destination of the object position pointer to the position of the copy destination object when or after the main program writes an object position pointer which refers to the position of the copy source object into the heap area during the execution of the second pointer updating means;
an identification determination means of determining that two object position pointers refer to an identical object when one of two object position pointers refers to a position of the copy source object and also when the other object position pointer refers to a position of the copy destination object in a process of the main program determining whether the two object position pointers refer to the identical position of the object during the execution of the second pointer updating means, wherein
the copy determination means determines whether data is written into a recording area of the copy source object or a recording area of the copy destination object when or after the main program writes the data in the recording area of an object, which is recorded in the heap area, during the execution of the object copying means or the second pointer updating means.

11. The memory management apparatus according to claim 8, wherein a stack area in which function frames, which temporarily record an execution result of a function executed by the main program and so on, are stacked in layers is provided in the data recording area, further comprising:
a third pointer updating means of scanning the function frame in the stack area from an upper toward lower of the function frame and updating a referential destination of an object position pointer which refers to a position of the copy source object, which is recorded in the stack area in order of upper to lower, to a position of a copy destination object which is copied by the object copying means; and
a barrier setting up means of setting up a barrier for controlling an execution of a function to the function frame to which a process of the third pointer updating means is executed last when an update process of an object position pointer executed by the third pointer updating means is interrupted, wherein
the first pointer updating means updates the referential destination of the object position pointer which refers to the position of the copy source object, which is recorded in the data recording area except for the stack area, to the position of the copy destination object, and
the barrier restarts the process executed by the third pointer updating means after an execution of a function is completed.

12. The memory management apparatus according to claim 8, wherein
part or all of the data recording area is allocated in the heap area and an area except for the data recording area in the heap area is determined to be the heap area,
the range setting up means can set up a limited range to an area to which the data recording area is allocated in the heap area,
the first pointer updating means updates a referential destination of an object position pointer which refers to the position of the copy source object, which is recorded in the data recording area in the limited range, to the position of the copy destination object and moves the data recording area in the limited range to an available area in the heap area, and
a referential destination of an object position pointer which refers to the position of the copy source object, which is recorded in the data recording area which is not included in the limited range, to the position of the copy destination object.

13. The memory management apparatus according to claim 11, wherein
part or all of the data recording area except for the stack area is allocated in the heap area and an area except for the data recording area in the heap area is determined to be the heap area,
the range setting up means can set up a limited range to an area to which the data recording area is allocated in the heap area,
the first pointer updating means updates a referential destination of an object position pointer which refers to the position of the copy source object, which is recorded in the data recording area in the limited range, to the position of the copy destination object and moves the data recording area in the limited range to an available area in the heap area, and
a referential destination of an object position pointer which refers to the position of the copy source object, which is recorded in the data recording area except for the limited range and the stack area, to the position of the copy destination object.

14. The memory management method according to claim 11, wherein
part or all of the data recording area including the stack area is allocated in the heap area and an area except for the data recording area in the heap area is determined to be the heap area,
the range setting up means can set up a limited range to an area to which the data recording area is allocated in the heap area,
the first pointer updating means updates a referential destination of an object position pointer which refers to the position of the copy source object, which is recorded in the data recording area except for the stack range, to the position of the copy destination object and moves the data recording area which is allocated in the limited range except for the stack area to an available area in the heap area,
a referential destination of an object position pointer which refers to the position of the copy source object, which is recorded in the data recording area except for the stack area which is not included in the limited range, to the position of the copy destination object,
the third pointer updating means scans the function frame in the stack area which is allocated in the heap area from an upper toward lower of the function frame, updates a referential destination of an object position pointer which refers to a position of the copy source object, which is recorded in the function frame in the limited range, to a position of the copy destination object, and moves the function frame in the limited range to an available area in the heap area,
a referential destination of an object position pointer which refers to a position of the copy source object, which is recorded in the function frame which is not included in the limited range, is updated to a position of the copy destination object, and
the barrier setting up means sets up the barrier to the function frame to which a process of the third pointer updating means is executed last when the process of the third pointer updating means is interrupted to execute the main program.

15. A computer-readable recording medium which records a memory management program to make a computer execute the memory management method described in claim 1.

16. The memory management method according to claim 2, wherein the object further includes the object position pointer as the data element, further comprising:
a second pointer updating step of updating a referential destination of an object position pointer which refers to a position of the copy source object in the heap area to a position of a copy destination object which is copied in the object copying step;
a referential destination changing step of changing a referential destination of the object position pointer to the position of the copy destination object when or after the main program writes an object position pointer which refers to the position of the copy source object into the heap area;
an identification determination step of determining that two object position pointers refer to an identical object when one of two object position pointers refers to a position of the copy source object and also when the other object position pointer refers to a position of the copy destination object in a process of the main program determining whether the two object position pointers refer to the identical position of the object, wherein
in the copy determination step, it is determined whether data is written into a recording area of the copy source object or a recording area of the copy destination object when or after the main program writes the data in the recording area of an object, which is recorded in the heap area, during the object copying step or the second pointer updating step.

17. The memory management method according to claim 2, wherein a stack area in which function frames, which temporarily record an execution result of a function executed by the main program and so on, are stacked in layers is provided in the data recording area, further comprising:
a third pointer updating step of scanning the function frame in the stack area from an upper toward lower of the function frame and updating a referential destination of an object position pointer which refers to a position of the copy source object, which is recorded in the stack area in order of upper to lower, to a position of a copy destination object which is copied in the object copying step; and
a barrier setting up step of setting up a barrier for controlling an execution of a function to the function frame to which the third pointer updating step is executed last when an update process of an object position pointer executed in the third pointer updating step is interrupted, wherein
the referential destination of the object position pointer which refers to the position of the copy source object, which is recorded in the data recording area except for the stack area, is updated to the position of the copy destination object in the first pointer updating step, and
the barrier restarts the process executed in the third pointer updating step after an execution of a function is completed.

18. The memory management method according to claim 3, wherein a stack area in which function frames, which temporarily record an execution result of a function executed by the main program and so on, are stacked in layers is provided in the data recording area, further comprising:
a third pointer updating step of scanning the function frame in the stack area from an upper toward lower of the function frame and updating a referential destination of an object position pointer which refers to a position of the copy source object, which is recorded in the stack area in order of upper to lower, to a position of a copy destination object which is copied in the object copying step; and
a barrier setting up step of setting up a barrier for controlling an execution of a function to the function frame to which the third pointer updating step is executed last when an update process of an object position pointer executed in the third pointer updating step is interrupted, wherein
the referential destination of the object position pointer which refers to the position of the copy source object, which is recorded in the data recording area except for the stack area, is updated to the position of the copy destination object in the first pointer updating step, and
the barrier restarts the process executed in the third pointer updating step after an execution of a function is completed.

19. The memory management method according to claim 2, wherein
part or all of the data recording area is allocated in the heap area and an area except for the data recording area in the heap area is determined to be the heap area,
in the range setting up step, a limited range can be set up to an area to which the data recording area is allocated in the heap area,
in the first pointer updating step, a referential destination of an object position pointer which refers to the position of the copy source object, which is recorded in the data recording area in the limited range, is updated to the position of the copy destination object and the data recording area in the limited range is moved to an available area in the heap area, and
a referential destination of an object position pointer which refers to the position of the copy source object, which is recorded in the data recording area which is not included in the limited range, is updated to the position of the copy destination object.

20. The memory management method according to claim 3, wherein
part or all of the data recording area is allocated in the heap area and an area except for the data recording area in the heap area is determined to be the heap area,
in the range setting up step, a limited range can be set up to an area to which the data recording area is allocated in the heap area,
in the first pointer updating step, a referential destination of an object position pointer which refers to the position of the copy source object, which is recorded in the data recording area in the limited range, is updated to the position of the copy destination object and the data recording area in the limited range is moved to an available area in the heap area, and
a referential destination of an object position pointer which refers to the position of the copy source object, which is recorded in the data recording area which is not included in the limited range, is updated to the position of the copy destination object.
